(19) United States
(12) Patent Application Publication
(10) Pub. No.: US 2016/0356637 A1
(43) Pub. Date: Dec. 8, 2016

(54) SENSOR TO DETECT CLOGGED DRAIN IN FREEZE/THAW APPLICATIONS

(71) Applicant: Parker-Hannifin Corporation, Cleveland, OH (US)

(72) Inventors: Raghujit Prasad KUNAPULI, Saint Charles, MO (US); Christian Dean PARKER, Washington, MO (US); Timothy A. PLASSMEYER, Union, MO (US); Max Allan WITTER, Washington, MO (US)

(21) Appl. No.: 15/171,038

(22) Filed: Jun. 2, 2016

Related U.S. Application Data
(60) Provisional application No. 62/169,754, filed on Jun. 2, 2015.

(51) Int. Cl. G01F 23/26; G08B 21/18

(52) U.S. Cl. CPC G01F 23/26; G08B 21/182; E03C 2001/2406

(57) ABSTRACT

A drain sensor includes a support member for placement relative to a drain, the support member including a cage. A sensor is attached to the support member and arranged within the cage, the sensor operative to provide an inductance measurement corresponding to a fluid level relative to a reference level

### RELATED APPLICATION DATA

The present application claims the benefit of the filing date of U.S. Provisional Patent Application Ser. No. 62/169,754 filed Jun. 2, 2015, which is incorporated herein by reference in its entirety.

### TECHNICAL FIELD

The present invention generally relates to drains and, more particularly, to a sensor that detects a clogged drain using inductive frequency characterization.

### BACKGROUND

Refrigerated display cases include a control system to maintain the temperature of a space relative to a set point by activating a refrigeration unit to cool the space. The refrigeration unit supplies sub-cooled refrigerant to an evaporator coil, which cools warm air from the space that is circulated across the evaporator coil.

When the warm air contacts the colder surface of the evaporator coil (e.g., in air conditioning systems) or when in a defrost mode (e.g., in refrigeration systems), water can accumulate on the evaporator. The water condensation runs down the sides of the evaporator coil and collects in a display case tub. The display case tub has a drain fitting and drain line attached thereto, which allows the water to drain from the display case tub.

Blockage in the drain line can occur due to food or liquid spills into the display case, as well as due to algae, fungus and/or bacterial growth, all of which may form particles that create restrictions in the drain line. Such restriction can cause water to back up into the display case tub. When the display case tub is full of water, the water will overflow out of the tub and into the surrounding area, potentially creating a safety hazard and/or water damage to the surrounding area. The water in the display case tub may also freeze and traditional level sensing devices fail to accurately operate in these scenarios. These limitations in display case tub drain designs can also result in problems and/or damage to the refrigeration system.

### SUMMARY

A combined fluid level sensor and/or drain cover (hereinafter referred to as a drain sensor) for detecting a clog within or around a drain utilizes a sensor (e.g., a solid state sensor, an inductive sensor, a sensor having a non-contact sensing element, or the like) having an inductance that varies based on the presence of substances in the area of the drain, and a support member to which the sensor is mounted. The support member forms a protective shroud around a sensing portion so as to protect it from contact with debris/substances that may fall into the display case tub.

An exemplary drain sensor in accordance with the present invention can include a support member having a cage configuration. The sensor may be attached to the support member and arranged within the cage, and the entire assembly may be placed in, over or around a drain that is to be monitored. The cage prevents large substances, such food particles, labels, wire ties and the like that may be unintentionally deposited in a refrigerated display case, from contacting the sensor and providing false readings. By monitoring changes in inductance of the sensor, a fluid, moisture or substance level around the drain can be determined. For example, as fluid level rises the inductance of the sensor also rises, and this increase (or decrease) can be measured and correlated to the level of the substance. If the detected level rises above a prescribed level, an alarm can be generated to notify the appropriate personnel.

According to one aspect of the invention, a drain sensor includes: a support member for placement relative to a drain, the support member including a cage; a sensing element attached to the support member and arranged within the cage; and measurement circuitry operatively coupled to the sensing element, wherein the measurement circuitry is operative to provide an inductance measurement of the sensing element, the inductance of the sensing element being proportional to a level of fluid, moisture or a substance relative to the sensing element.

In one embodiment, the sensing element includes an inductor forming an impedance transformer of the surrounding fluid, moisture or substance, and the measurement circuitry is configured to supply an oscillating current to the inductor and to calculate an inductance of the impedance transformer based on a resonant frequency of the impedance transformer.

In one embodiment, the measurement circuitry is configured to determine the level based on a predefined mapping between a plurality of different inductances and a plurality of different levels of a fluid, moisture or substance corresponding to the different inductances.

In one embodiment, the cage includes an open end and a closed end.

In one embodiment, the drain sensor includes a base member removable attached to the open end of the cage.

In one embodiment, the closed end is formed by a metallic disk member attached to a first end of the cage, and the open end is formed by an annular member attached to a second end of the cage opposite the first end.

In one embodiment, the sensing element is fixedly attached to the disk member and extends toward the open end.

In one embodiment, the cage comprises a screen have a bar or cross-hatch configuration.

In one embodiment, the support member comprises a plurality of fastener receivers for fixing the support member to a support surface.

In one embodiment, the drain sensor includes at least one of a wired communication device or wireless communication device communicatively coupled to the sensing element and operative to communicate measurements made by the sensing element to a device remote from the drain sensor.

In one embodiment, an inductance of the sensing element corresponds to a level of fluid, moisture or solid substance present in the cage.

In one embodiment, the inductance measurement increases as fluid, moisture or substance level increases.

In one embodiment, the support member is configured to be inserted into the drain, or immediately over the drain.

In one embodiment, the sensing element comprises a two-dimensional coil.

In one embodiment, the sensing element comprises a three-dimensional coil.

According to another aspect of the invention, a system for detecting a substance in a drain includes the drain sensor as described herein, and a controller communicatively coupled to the drain sensor to receive data corresponding to an inductance of the sensing element, wherein the controller is configured to detect the fluid, moisture and/or substance in the drain based on the inductance of the sensing element.

In one embodiment, the controller is configured to at least one of: generate an alarm when the measured fluid level exceeds a prescribed level, or provide an indication of the presence of fluid; or provide an indication of a rate of fluid rise in the drain.

In one embodiment, the system includes a refrigerated display case having a drain, wherein the drain sensor is arranged relative to the drain to detect fluid level at the drain.

In one embodiment, the controller is configured to determine the substance level based on a mapping between inductance and substance level.

In one embodiment, the mapping is configured such that increasing inductance corresponds to increasing fluid, moisture or substance level.

According to another aspect of the invention, a method for determining a fluid level in an area, wherein an inductive sensing element is arranged in the area, includes: mapping fluid level to inductance of the sensing element, wherein increasing inductance corresponds to increasing fluid level; measuring an inductance of the sensing element; and determining fluid level based on the measured inductance and the mapping between fluid level and inductance.

In one embodiment, the method includes determining the fluid level when a temperature in the area being monitored is less than 32 degrees F.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Embodiments of this invention will now be described in further detail with reference to the accompanying drawings.

FIG. 1 is a schematic system diagram of a refrigerated display case that includes a drain sensor in accordance with an embodiment of the present invention.

FIG. 2 is a schematic diagram of an exemplary system that includes a controller and a drain sensor in accordance with an embodiment of the present invention.

FIG. 3A is a schematic diagram of a simple conventional transformer.

FIG. 3B illustrates an exemplary sensor in accordance with the present invention.

FIG. 4A illustrates an exemplary sensor package in accordance with an embodiment of the present invention.

FIG. 4B illustrates another exemplary sensor package in accordance with an embodiment of the present invention.

FIG. 5A is a bottom perspective view of an exemplary drain sensor in accordance with an embodiment of the present invention.

FIG. 5B is a top perspective view of the drain sensor of FIG. 5A.

FIG. 6A is a top perspective view of an exemplary drain sensor in accordance with another embodiment of the present invention.

FIG. 6B is a bottom perspective view of the drain sensor of FIG. 6A.

FIG. 6C is an exploded view of the support portion of the drain sensor of FIGS. 6A-6B.

FIG. 7 is a basic flow chart illustrating exemplary steps for monitoring a status of a drain in accordance with the present invention.

### DETAILED DESCRIPTION

Principles of the present invention have particular application to refrigerated display cases (both medium temperature (generally above 32 degrees F.) and low-temperature (generally below 32 degrees F.)) and thus will be chiefly described in this context. It will be appreciated, however, that principles in accordance with the present invention may find application in other fields in which it is desired to determine the status of a drain.

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

A drain sensor for detecting drain clogs and corresponding system in accordance with the present invention determine when a level of a substance (e.g., water, ice, etc.) within a drain exceeds a prescribed level. In the context of a refrigerated display case, the term “substance” includes fluids (e.g., juices, milk, coffee, water, food juice, etc.) and solids (e.g., fluids in a frozen state such as ice, as well as other solids including dust, dirt, labels, paper packaging, etc.). In the context of the present invention, the term “substance” does not include solid metallic objects.

Upon detecting an increase in the level of a substance within or around the drain, various actions may be taken. For example, if the level of the substance relative to the drain exceeds a prescribed level, then an alarm may be generated to inform the appropriate personnel of a possible clogged drain. Additionally or alternatively, an output may be provided showing the actual level and/or a rate of increase in the level of the substance.

According to one aspect of the present invention, a drain sensor is provided having a body with a first annular end, and a second disk-shape end. The drain sensor further includes a sensor disposed on the second end and extending toward the first end. The sensor is configured to provide an inductance that changes in response to contact with or presence of a substance, such as water, ice or like substance. Preferably, the sensor is arranged to detect a level of the substance relative to the opening in the first end.

The drain sensor is preferably configured to detect a liquid level indicative of a clogged drain line when the sensor provides an output indicative of contact (or near contact) with fluid. The sensor may be employed in a circuit including the sensor, the circuit configured to detect when the sensor provides an output indicative of fluid contact. In some embodiments, the drain sensor may be employed with a controller, where the controller is in communication with the output of the circuit and/or sensor, and is configured to communicate a signal indicative of a clogged drain line based on the output of the sensor, as explained below. The controller may include a mapping, such as a look-up table or the like, stored in memory, the mapping including a plurality of different inductances of the sensor along with a corresponding fluid, moisture or substance level for each inductance of the sensor. Based on a measured inductance of the sensor, the controller can retrieve the corresponding fluid, moisture or substance level from memory.

In one embodiment the drain sensor includes a primary circuit formed by an inductor having a fixed inductance in parallel with a capacitor having a known capacitance. An oscillator supplies an oscillating AC current to the primary circuit and generates a magnetic field in the surrounding material that produces eddy currents in the surrounding material. By doing so, the impedance in the surrounding material is transformed to the primary circuit, and this impedance can be measured to determine the presence of fluid, moisture and/or a substance, e.g., by mapping different measured inductances to different fluid levels, moisture levels, etc.

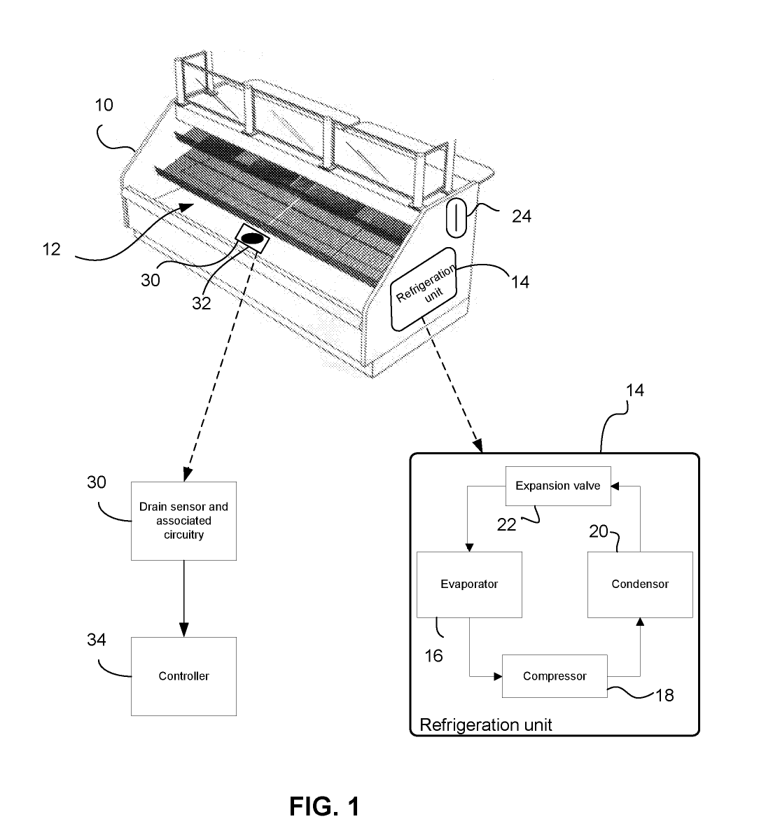

Referring to FIG. 1, a refrigerated display case 10 for conditioning a space 12 is shown. As is well known, refrigerated display cases provide a refrigerated environment in which food products may be displayed without being exposed to warm temperatures. The refrigerated display case 10 includes a refrigeration unit 14 having an evaporator coil 16, a compressor 18, condenser coil 20 and an expansion valve 22 for providing cooling operation. While the refrigeration unit is shown as being part of the display case, portions of the refrigeration unit may be located remote from the display case. The refrigerated display case 10 may be controllably operated by a device 24 (e.g., a thermostat, controller or the like) operatively coupled to the space 12 and the refrigeration unit 14. For medium temperature applications (e.g., above 32 degrees F.), warm air from the space 12 is circulated across the evaporator coil 16, in which a two-phase refrigerant removes heat from the air. When the warm air contacts the colder surface of the evaporator coil 16, condensation of water can occur. The water condensation is collected and drained through a drain 32, where a drain sensor 30 including a sensor and associated circuitry for measuring an inductance is arranged relative to the drain 32 to detect a clog in the drain 32. For low temperature applications (e.g., where temperatures are below 32 degrees F.), liquid (water, food juices, spilled substances, cleaning agents, etc.) may collect during a defrost cycle and/or during a wash down cycle, and this liquid is also collected and routed to the drain 32.

The drain sensor 30 enables detection of a clog in a drain line. A controller 34, which may be located within the refrigerated display case 10 or remote from it, may be operatively coupled to the drain sensor 30 to receive data indicative of a level of a fluid, moisture or substance relative to the drain 32, as explained below.

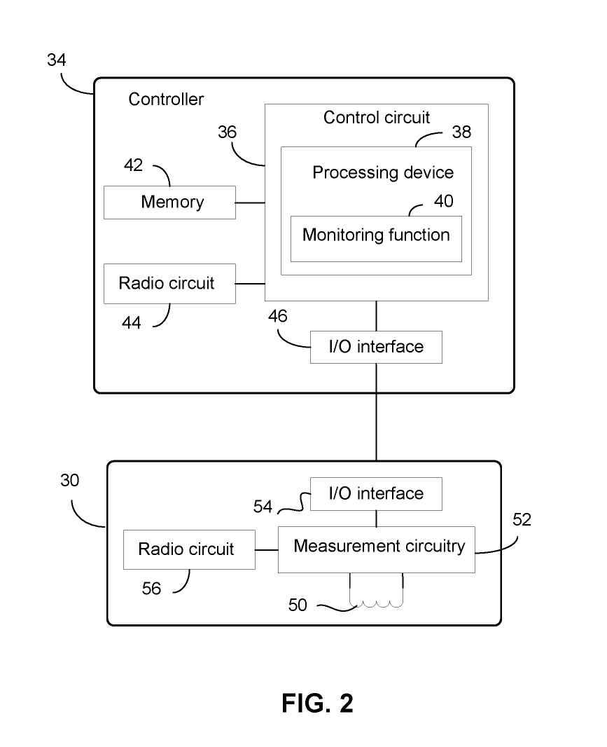

With additional reference to FIG. 2, schematically shown is an exemplary controller 34 and drain sensor 30 in accordance with the present invention. While the controller 34 and drain sensor 30 are shown as separate devices, part or all of the controller 34 may be integrated with the drain sensor 30 to form a single integrated unit.

The controller 34 includes a control circuit 36 that is responsible for overall operation of the controller 34. For this purpose, the control circuit 36 includes a processing device 38 (e.g., a processor) that executes various applications, such as a monitoring function 40 for monitoring a status of the drain 32 as described in greater detail below. The monitoring function 40 may be implemented in the form of logical instructions that are executed by the processing device 38.

The processing device 38 of the control circuit 36 may be a central processing unit (CPU), microcontroller, microprocessor, or the like. The processing device 38 executes code stored in a memory (not shown) within the control circuit 36 and/or in a separate memory, such as a memory 42, in order to carry out operation of the controller 34. The memory 42 may be, for example, one or more of a buffer, a flash memory, a hard drive, a removable media, a volatile memory, a non-volatile memory, a random access memory (RAM), or other suitable device. In a typical arrangement, the memory 42 includes a non-volatile memory for long term data storage and a volatile memory that functions as system memory for the control circuit 36. The memory 42 may exchange data with the control circuit 36 over a data bus. Accompanying control lines and an address bus between the memory 42 and the control circuit 36 also may be present. The memory 42 is considered a non-transitory computer readable medium.

The controller 34 may include communications circuitry that enables the controller 34 to establish various wireless communication connections. In the exemplary embodiment, the communications circuitry includes a radio circuit 44. The radio circuit 44 includes one or more radio frequency transceivers and an antenna assembly (or assemblies). The controller 34 may be capable of communicating using more than one standard (e.g., WiFi or Bluetooth interface). Therefore, the radio circuit 44 represents each radio transceiver and antenna needed for the various supported connection types. The controller 34 is configured to engage in wireless communications using the radio circuit 44, such as data transfers and the like.

The controller 34 may further include one or more input/output (I/O) interface(s) 46. The I/O interface(s) 46 may be in the form of typical electronic device I/O interfaces and may include one or more electrical connectors for operatively connecting the controller 34 to another device (e.g., the drain sensor 30). The I/O interface may include analog and digital inputs/outputs, communications interfaces (e.g., USB) and the like.

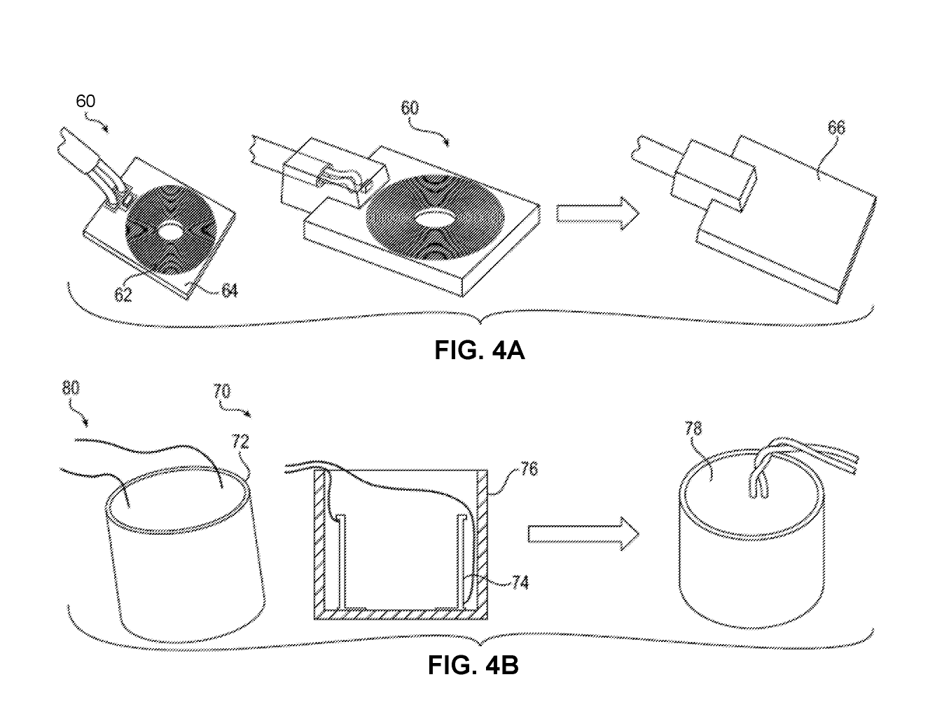

With continued reference to FIG. 2, the drain sensor 30 includes a coil 50 or other inductive sensing device operatively coupled to measurement circuitry 52. The coil 50 may be packaged as a two-dimensional package or as a three-dimensional package as described in further detail below with respect to FIGS. 4A and 4B. The measurement circuitry 52 is configured to measure the inductance of the coil 50. Such measurement may be represented, for example, as digital value or as an analog voltage or current signal that is proportional to the change in measured inductance. Operation of the measurement circuitry 52 is described below.

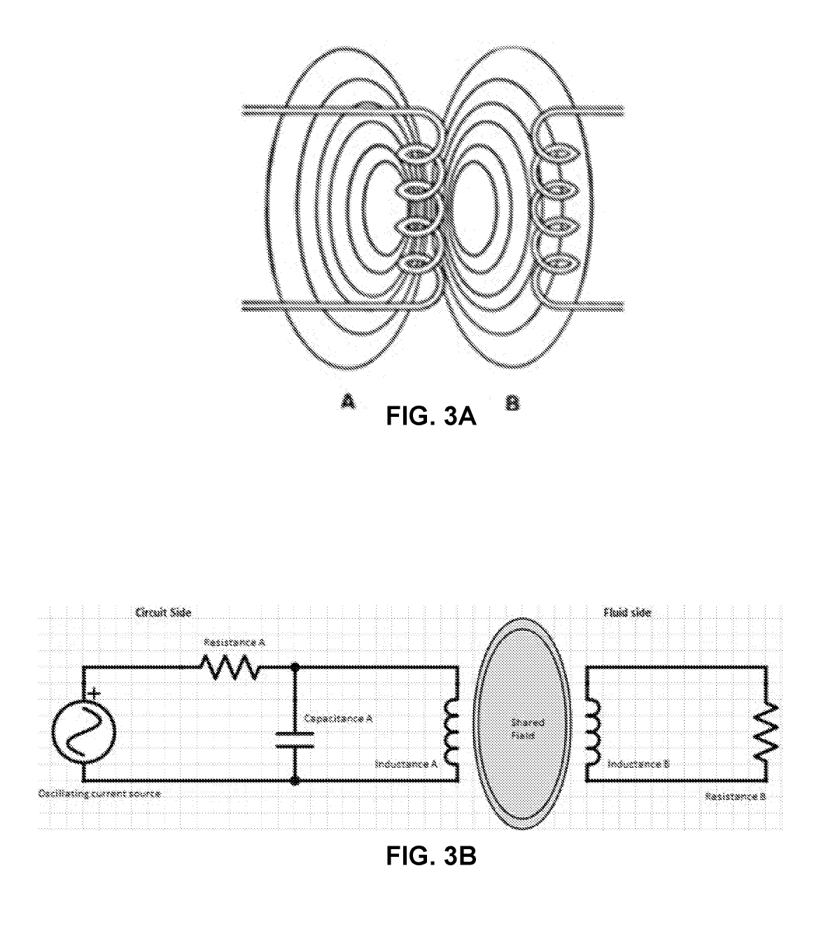

A classical transformer refers to a two coil system where two coils share a field. Current in the first coil stores energy in the magnetic field, and that energy is “transformed” via the field into the second coil in the form of current. FIG. 3A illustrates such configuration, where “A” is the primary coil and “B” is the secondary coil.

The physical arrangement of the sensor is different from the configuration in FIG. 3A. Referring to FIG. 3B, an exemplary sensor in accordance with the present invention has a physical primary coil having a fixed inductance (inductance A), while the secondary coil is formed by the fluid, substance, or moisture. The field emitted by the primary coil causes circular currents to form in the fluid, moisture or substance. These current then generate their own inductive load (inductance B). Also present in both coils is resistance (resistance A and resistance B, respectively). The primary side circuit (i.e., the portion of the circuit to the left of the shared field) also has a capacitance that is fixed and independent of fluid, moisture or substance level. The more fluid, moisture or substance, the more shared field and thus the more induced inductance.

The total Impedance (expressed by the letter Z) experienced by the current is:

$$Z = [ Total resistance of both coils ] + [ Osc frequency * Total Inductance ] - [ \frac{1}{Osc frequency * Cap A} ]$$

Both the capacitance and the inductance of the primary and secondary circuits depend on the oscillation frequency. There exists a single frequency value (the resonant frequency) for which the capacitive load and inductive impedance terms cancel each other out. When this occurs, the power losses on the current arrive at a local minimum.

The measurement circuitry 52 changes its frequency of oscillation until it finds the resonant frequency. When this occurs, the net impedance can be calculated. This transformed impedance is characteristic of the level of the fluid, moisture or substance. Higher levels engage more magnetic field allowing for more load sharing.

Like the controller 34, the drain sensor 30 may include one or more input/output (I/O) interface(s) 54 and a radio circuit 56. The I/O interface 54 and radio circuit 56 are similar to the I/O interface 46 and radio circuit 44 of the controller 34. Thus, and for sake of brevity, the description of these devices will not be repeated here.

The I/O interface 54 and/or radio circuit 56 enable the controller 34 to be communicatively coupled to the measurement circuitry 52 and/or coil 50 to receive data corresponding to an inductance measurement of the coil 50. Based on the inductance measurement of the coil 50, the controller 34 is configured to determine the presence of a substance in the drain and/or a level of the substance.

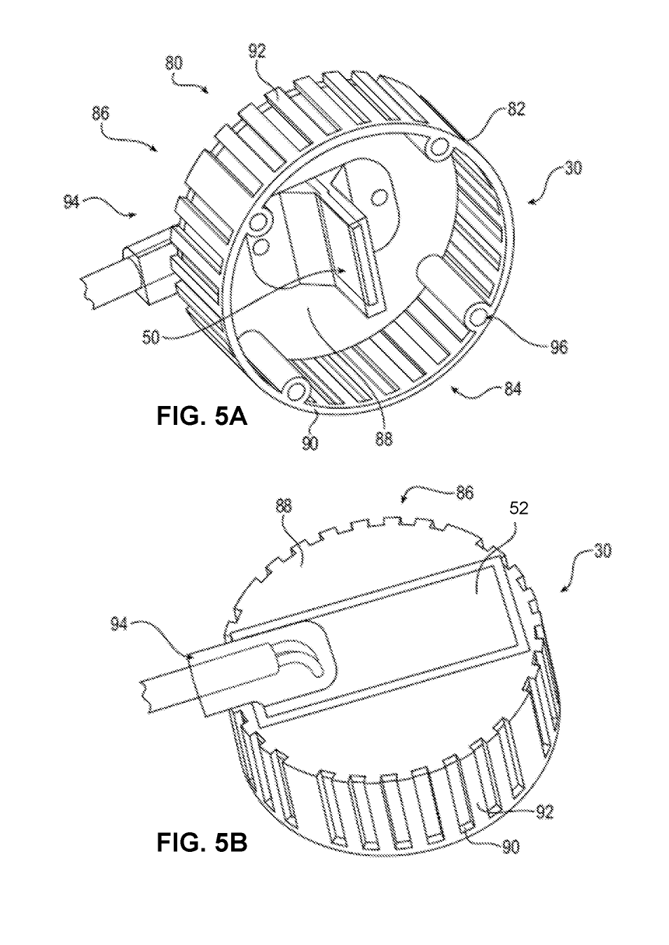

Referring briefly to FIGS. 4A and 4B, illustrated are exemplary coil packages that may be used in the drain sensor 30. FIG. 4A illustrates a two-dimensional package 60, where conductive traces 62 are formed on a printed circuit board 64, the traces, for example, having a spiral configuration. It will be appreciated that other configurations may be employed for the traces depending on the requirements of the specific application. Wires electrically connect the traces 62 to the measurement circuitry 52, thus enabling measurement of inductance. The spiral traces 62 and printed circuit board 64 may be placed within a protective housing 66, which may be formed from a plastic or like material. The housing 66 is attached to a support member of the drain sensor 30 as described below with respect to FIGS. 5A and 5B.

FIG. 4B illustrates an embodiment that implements a three-dimensional coil package 70, where a conductive wire is coiled 72 one loop above the other to form a wire stack 74. The stack 74 then is placed in a protective housing 76 (e.g., a plastic housing), such as a cylindrical housing, and a potting compound 78 or the like is placed within the housing so as to seal and protect the wire stack 74. Wires 80 electrically connect the stack 74 to the measurement circuitry 52

Referring now to FIGS. 5A and 5B, illustrated are bottom and top perspective views of an exemplary drain sensor 30 in accordance with an embodiment of the present invention. It is noted that while the drain sensor 30 is illustrated having a cylindrical shape, other shapes may be employed depending on the specific application for the drain sensor. For example, a rectangular shape may be employed when the drain 32 is formed as a narrow channel.

The drain sensor 30 includes a support member 80 for placement relative to the drain 32. In one embodiment, the support member 80 is configured to be inserted into the drain 32, and in another embodiment the support member 80 is configured to be placed immediately over the drain 32 and/or near the drain 32.

The support member 80 preferably defines a cage portion 82 (e.g., a screen with a bar or cross-hatch configuration) having an open end 84 and a closed end 86. The closed end 86 may be formed, for example, by a disk member 88 attached to one end of the cage portion 82 (e.g., a first end), and the open end 84 may be formed by an annular member 90 attached to the opposite end (e.g., a second end) of the cage portion. The annular member 90 and the disk member 88 may be connected to one another via a plurality of supports 92.

In FIGS. 5A and 5B, the supports 92 are shown having a bar-like configuration. In this regard, a plurality of elongated members arranged generally parallel to one another attach the disk member 88 to the annular member 90. A spacing between adjacent elongated members is preferably selected to prevent substances having dimensions over a prescribed size from passing between adjacent supports 92.

While a bar configuration is illustrated, other configurations are possible. For example, additional supports (not shown) may be arranged perpendicular to the supports 92 and circumferentially around the cage portion 82. In another embodiment, the supports 92 may be arranged to form a cross-hatch configuration.

In one embodiment, the cage portion 82 forms a cylindrical housing that houses and protects the coil 50. The measurement circuitry 52 and radio circuitry 56 may be arranged within the cage portion 82 or external to the cage portion (e.g., on a top surface of the support member 80—see FIG. 5B). Preferably, the measurement circuitry 52 is arranged within the cage portion 82 to provide protection from falling substances/spills/leaks that are typically encountered in a refrigerated display case. A wire harness 94, which may be located perpendicular to the coil 50, provides signals to and from the controller 34 (e.g., supply voltage to the coil and signal voltage from the coil). Alternatively or additionally, power may be provided to the coil via a power storage device, e.g., a battery or the like).

The support member 80 may include one or more receiving means 96, such as through holes or the like, for receiving respective fasteners (e.g., a threaded fastener—not shown). The receiving means 96 in conjunction with the fasteners enable the support member 80 to be fixedly attached to a support surface of the refrigerated display case 10. For example, in one embodiment the drain sensor 30 can be connected to a drain cap of a display case. As the fluid (water or other) level rises in the display case, fluid, moisture and/or substances enter through the exterior openings of the cage portion 82 and, if the drain is clogged, submerges at least part of the coil 50.

As noted above, the sensing portion of the drain sensor 30 includes a sensor (coil 50). The coil 50 is attached to the support member 80 and arranged within the cage portion 82. For example, the coil may be fixedly attached to the disk member 88 and extend toward the open end 84. As the level of a fluid, moisture or substance rises, a larger area around the coil 50 is exposed to the fluid/moisture/substance, thereby affecting the inductance of the coil 50. Thus, the inductance of the coil 50 varies in the presence of fluid, moisture or substance and by measuring the inductance of the coil a level of the fluid, substance and/or amount of moisture in or near the cage portion 82 can be deduced.

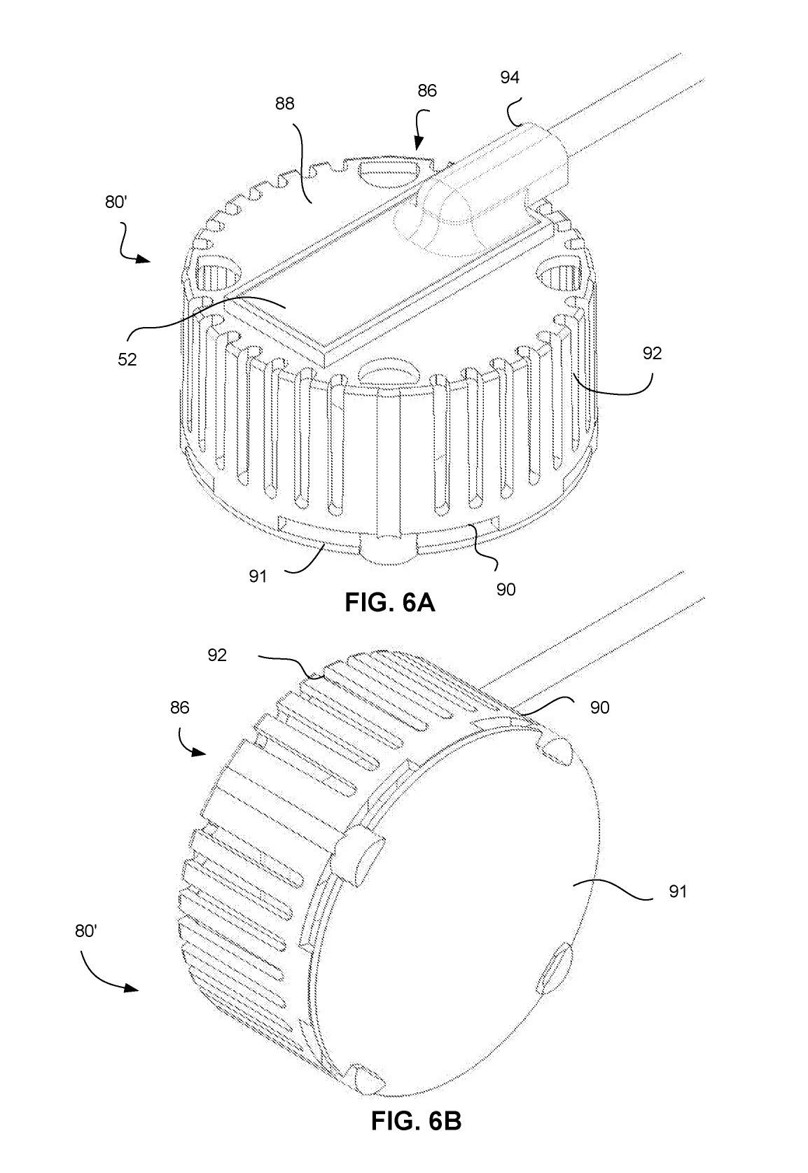

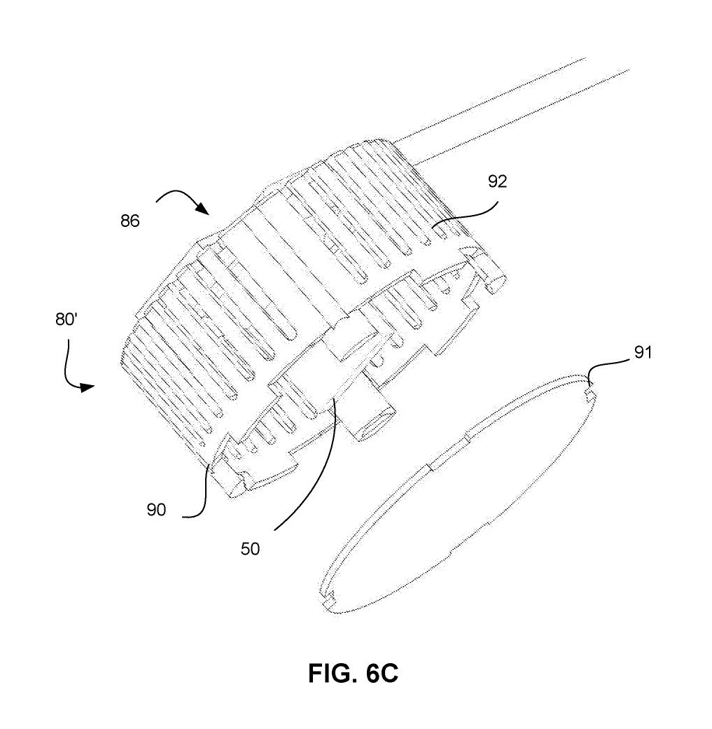

Referring to FIGS. 6A-6C, illustrated is another embodiment of a support member in accordance with the present invention. The support member 80′ is similar to the support member 80 of FIGS. 5A-5B and therefore only differences are discussed here. The support member 80′, unlike the support member 80 of FIGS. 5A-5B, does not have an open end but instead has a base plate 91 removably attached to the annular member 90. The base plate 91 can be freely moved to any desired location relative to the drain 32. This may be advantageous, for example, to prevent false triggers during a wash-down cycle where significant fluid collects at the drain 32, even when the drain is not clogged.

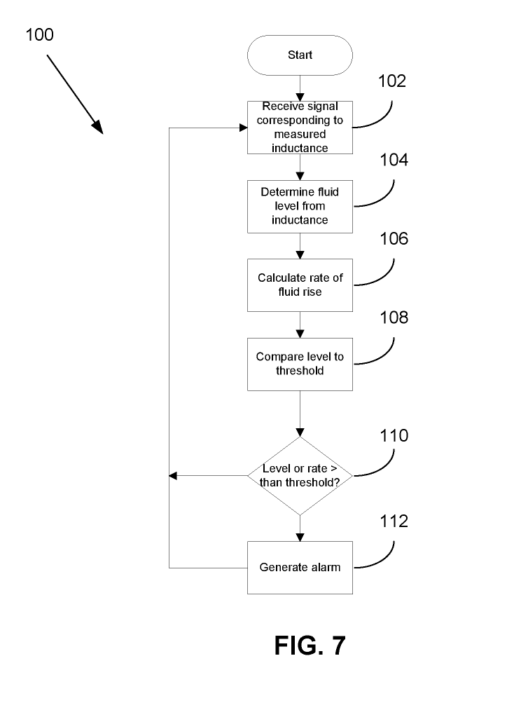

With additional reference to FIG. 7, illustrated are logical operations 100 to implement an exemplary method of monitoring a drain using the drain sensor 30 in accordance with the present invention. The exemplary method may be carried out by executing an embodiment of the monitoring function 40, for example. Thus, the flow chart of FIG. 7 may be thought of as depicting steps of a method carried out by the controller 34 and/or drain sensor 30. Although FIG. 7 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the monitoring function 40 may begin at step 102 where the measurement circuitry 52 obtains a measurement of the inductance of coil 50. As noted above, the inductance of coil 50 is affected by the presence of a liquid, such as water, or a solid, e.g., ice, food particles, etc. The measured inductance of coil 50 then is communicated to the controller 34 for further processing. Such communication may be by way of a wireless communication channel using the radio circuits 44 and 56, or by way of a wired connection using the I/O interfaces 46 and 54 (e.g., a USB or other serial connection).

Next at step 104 the fluid level is calculated. Such calculation, for example, may be based on the measured inductance of the coil 50. For example, testing has shown that a test (sample) coil has an inductance of about 19.5 μH when in free space (i.e., no liquid in the immediate vicinity of the coil 50), about 20.9 μH when about fifty percent of the coil is immersed in water, and about 21.714 μH when the coil 50 is about seventy-five percent immersed in water. Accordingly, the relationship between inductance of the coil and fluid level is linear and, therefore, the fluid level can be calculated based on the measured inductance of the coil 50 and the known linear relationship.

It is also noted that in the presence of moisture/liquid the inductance of the coil 50 increases. This is in contrast to the behavior of the coil 50 when in the presence of metal objects, where the inductance of the coil 50 decreases.

At step 106, the rate of fluid rise may optionally be calculated. For example, the change in inductance of the coil 50 over time can be used to calculate the rate at which the liquid level is rising or falling. Such information, for example, may be helpful in determining the severity of the drain clog and/or the success of a defrost cycle.

Moving to step 108, the measured level and/or rate are compared to prescribed threshold levels to determine if further action is required. The threshold levels, for example, may be user programmable to allow system customization. If at step 110 the measured/calculated level or rate do not exceed respective prescribed threshold levels, the method moves back to step 102 and repeats. However, if measured/calculated level or rate do exceed the respective prescribed thresholds, the method moves to step 112 where an alarm is generated (e.g., an audible and/or visual alarm such as an LED sequence), and then the method moves back to step 102.

The drain sensor in accordance with the present invention is advantageous for a number of reasons. For example, the drain sensor 30 does not use any moving parts and therefore is not subjected to mechanical wear. Additionally, because the sensor does not have any dependency on fluid conductivity, the fluid detected by the drain sensor 30 may include other constituents besides water, such as orange juice, coffee, dust, dirt, food juices, etc. Further, the drain sensor 30 can operate even when the liquid freezes (e.g., it can detect ice) and can be configured such that it does not include exposed conductors or the like that may corrode. This is in contrast to commercially available condensate drain sensors, which have an operating limit of 32 degrees F. or above and/or have exposed conductors.

The cage design eliminates false alarms due to the sensor being covered and protected by the cage portion 82. Also, the drain sensor 30 along with its control logic has the ability to predict clogged drains based on rate of fill and rate of decay of the historical data, and can categorize alarms as having different levels of urgency (e.g., High, Medium, Low) based on rate of fill, rate of decay height of fluid sensed and use of historical data.

While only selected embodiments have been chosen to illustrate the present invention, it will be apparent to those skilled in the art from this invention that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. The terms of degree such as “substantially”, “about” and “approximately” as used herein mean a reasonable amount of deviation of the modified term such that the end result is not significantly changed. Thus, the foregoing descriptions of the embodiments according to the present invention are provided for illustration only, and not for the purpose of limiting the invention as defined by the appended claims and their equivalents.

What is claimed is:

1. A drain sensor, comprising:
a support member for placement relative to a drain, the support member including a cage;
a sensing element attached to the support member and arranged within the cage; and
measurement circuitry operatively coupled to the sensing element, wherein the measurement circuitry is operative to provide an inductance measurement of the sensing element, the inductance of the sensing element being proportional to a level of fluid, moisture or a solid substance relative to the sensing element.

2. The drain sensor according to claim 1, wherein the sensing element comprises an inductor forming an impedance transformer of the surrounding fluid, moisture or solid substance, and the measurement circuitry is configured to supply an oscillating current to the inductor and to calculate an inductance of the of the impedance transformer based on a resonant frequency of the impedance transformer.

3. The drain sensor according to claim 2, wherein the measurement circuitry is configured to determine the level based on a predefined mapping between a plurality of different inductances of the sensing element and a plurality of different levels of a fluid, moisture or solid substance corresponding to the different inductances.

4. The drain sensor according to claim 1, wherein the cage includes an open end and a closed end.

5. The drain sensor according to claim 4, further comprising a base member removable attached to the open end of the cage.

6. The drain sensor according to claim 4, wherein the closed end is formed by a metallic disk member attached to a first end of the cage, and the open end is formed by an annular member attached to a second end of the cage opposite the first end.

7. The drain sensor according to claim 6, wherein the sensor is fixedly attached to the disk member and extends toward the open end.

8. The drain sensor according to claim 1, wherein the cage comprises a screen have a bar or cross-hatch configuration.

9. The drain sensor according to claim 1, wherein the support member comprises a plurality of fastener receivers for fixing the support member to a support surface.

10. The drain sensor according to claim 1, further comprising at least one of a wired communication device or wireless communication device communicatively coupled to the sensing element and operative to communicate inductance measurements to a device remote from the drain sensor.

11. The drain sensor according to claim 1, wherein an inductance of the sensing element corresponds to a level of fluid, moisture or solid substance present in the cage.

12. The drain sensor according to claim 11, wherein the inductance measurement increases as fluid, moisture or substance level increases.

13. The drain sensor according to claim 1, wherein the support member is configured to be inserted into the drain, or immediately over the drain.

14. The drain sensor according to claim 1, wherein the sensing element comprises a two-dimensional coil.

15. The drain sensor according to claim 1, wherein the sensing element comprises a three-dimensional coil.

16. A system for detecting a substance in a drain, comprising:
the drain sensor according to claim 1; and
a controller communicatively coupled to the drain sensor to receive data corresponding to an inductance measurement provided by the sensor, wherein the controller is configured to detect the fluid, moisture or substance level in the drain based on the inductance measurement provided by the sensor.

17. The system according to claim 16, wherein the controller is configured to at least one of:
generate an alarm when the measured fluid level exceeds a prescribed level, or
provide an indication of the presence of fluid; or
provide an indication of a rate of fluid rise in the drain.

18. The system according to claim 16, further comprising a refrigerated display case having a drain, wherein the drain sensor is arranged relative to the drain to detect fluid level at the drain.

19. The system according to claim 16, wherein the controller is configured to determine the substance level based on a mapping between inductance and substance level.

20. The system according to claim 19, wherein the mapping is configured such that increasing inductance corresponds to increasing substance level.

21. A method for determining a fluid level in an area, wherein an inductive sensor is arranged in the area, the method comprising:
mapping fluid level to inductance of the sensor, wherein increasing inductance corresponds to increasing fluid level;
measuring an inductance of the sensor; and
determining fluid level based on the measured inductance and the mapping between fluid level and inductance.

22. The method according to claim 21, further comprising determining the fluid level when a temperature in the area being monitored is less than 32 degrees F.
